(19) United States
(12) Patent Application Publication
(10) Pub. No.: US 2012/0235947 A1
(43) Pub. Date: Sep. 20, 2012

(54) MAP INFORMATION PROCESSING DEVICE

(76) Inventors: Saeko Yano, Hyogo (JP); Mitsuo Shimotani, Tokyo (JP)

(21) Appl. No.: 13/513,147

(22) PCT Filed: Jan. 29, 2010
(86) PCT No.: PCT/JP2010/000548

§ 371 Date: May 31, 2012

(51) Int. Cl. G06F 3/041

(52) U.S. Cl. 345/173

(57) ABSTRACT

In order to enable the user to intuitively and easily perform an operation of changing the display of a map thereon while maintaining the viewability of the map, a map information processing device in accordance with the present invention includes a display unit for displaying a map, a three-dimensional input unit for detecting a three-dimensional position of an object to be detected with respect to a display surface of the display unit, and a control unit for displaying a map having the same display center as an original display position with a scale according to the distance between the object to be detected which is detected by the three-dimensional input unit and the display surface on the display unit.

### FIELD OF THE INVENTION

The present invention relates to a map information processing device which displays a map. More particularly, it relates to a technique of enabling the user to cause the map information processing device to change the display mode of a map by performing a predetermined operation on the screen of a display unit.

### BACKGROUND OF THE INVENTION

As a map information processing device which displays a map, patent reference 1 discloses a CRT display device which is used for monitoring a plant system, and which can promptly display a portion which the user desires to view from the whole of the system. This CRT display device detects the position of the user's finger with respect to the display surface of the display device, and changes the display scale of a map according to the distance in a perpendicular direction between the display surface and the fingertip (the Z coordinate of the fingertip). The CRT display device also sets the position of the finger (the position determined by X and Y coordinates of the finger) with respect to the display surface as the display center of the map.

Further, patent reference 2 discloses a map display device which enables a map image to be rotated in a direction desired by the user. This map display device enables the user to trace a predetermined straight line with a pen touch to rotate a map and change the display angle of the map. Further, patent reference 3 discloses a map display device which makes it easy for the user to grasp the current position of a vehicle. Because this map display device is constructed in such a way as to display a subwindow in a main window, the user can view the different screens simultaneously.

### RELATED ART DOCUMENT

### Patent Reference

Patent reference 1: Japanese Unexamined Patent Application Publication No. Hei 4-128877

Patent reference 2: Japanese Unexamined Patent Application Publication No. 2002-310677

Patent reference 3: Japanese Unexamined Patent Application Publication No. Hei 7-270172

According to the technique disclosed by above-mentioned patent reference 1, when the position of the user's finger shifts from the center of the display surface, the display center of the map varies and the map moves. This happens also at a time when the user changes the display scale, and there arises a problem that the map becomes difficult to see.

Further, a problem with the technique disclosed by patent reference 2 is that the operation of tracing a straight line cannot be connected easily and apparently with an operation of rotating a map, and is not intuitive to use. In addition, a problem with the map display device disclosed by patent reference 3 is that because a subwindow cannot be moved to an arbitrary position, and therefore the user must close the subwindow in order to view a screen under the subwindow, and therefore the map display device is user-unfriendly.

The present invention is made in order to solve the above-mentioned problems, and it is therefore an object of the present invention to provide a map information processing device which enables the user to perform an operation of changing the display of a map intuitively and easily thereon while maintaining the viewability of the map.

### SUMMARY OF THE INVENTION

In accordance with the present invention, there is provided a map information processing device including: a display unit for displaying a map; a three-dimensional input unit for detecting a three-dimensional position of an object to be detected with respect to a display surface of the display unit; and a control unit for displaying a map having a same display center as an original display position with a scale according to a distance between the object to be detected which is detected by the three-dimensional input unit and the display surface on the display unit.

Because the map information processing device in accordance with the present invention is constructed in such away as to display a map having the same display center as the original display position with the scale according to the distance between the object to be detected which is detected by the three-dimensional input unit and the display surface on the display unit, the map information processing device enables the user to intuitively and easily perform an operation of changing the display of the map thereon while maintaining the viewability of the map even when the position of the user's finger shifts from the center of the display surface.

### BRIEF DESCRIPTION OF THE FIGURES

FIG. 1 is a block diagram showing the structure of a map information processing device in accordance with Embodiment 1 of the present invention;

FIG. 2 is a view showing a relationship between coordinates showing the three-dimensional position of a finger which is detected by a touch panel and the display surface of a display unit in the map information processing device in accordance with Embodiment 1 of the present invention;

FIG. 3 is a flow chart showing an operation of a menu operation determining unit included in a control unit of the map information processing device in accordance with Embodiment 1 of the present invention;

FIG. 4 is a view showing an example in which data are stored in a touch position locus storage unit disposed in the map information processing device in accordance with Embodiment 1 of the present invention;

FIG. 5 is a view showing operation examples in a case of enlarging or reducing a map in the map information processing device in accordance with Embodiment 1 of the present invention;

FIG. 6 is a view showing an operation example in a case of scrolling a map in the map information processing device in accordance with Embodiment 1 of the present invention;

FIG. 7 is a view showing operation examples in a case of confirming an operation in the map information processing device in accordance with Embodiment 1 of the present invention;

FIG. 8 is a flow chart showing the details of behavior determining processing carried out by the map information processing device in accordance with Embodiment 1 of the present invention;

FIG. 9 is a flow chart showing an operation of a map drawing unit included in the control unit of the map information processing device in accordance with Embodiment 1 of the present invention;

FIG. 10 is a view showing an example of a display scale table and a scroll speed table for use in the map information processing device in accordance with Embodiment 2 of the present invention;

FIG. 11 is a flow chart showing the details of behavior determining processing carried out by the map information processing device in accordance with Embodiment 2 of the present invention;

FIG. 12 is a flow chart showing an operation of a map drawing unit included in a control unit of the map information processing device in accordance with Embodiment 2 of the present invention;

FIG. 13 is a view showing an operation example in a map information processing device in accordance with Embodiment 3 of the present invention;

FIG. 14 is a view showing another operation example in the map information processing device in accordance with Embodiment 3 of the present invention;

FIG. 15 is a view for explaining an operation of the map information processing device in accordance with Embodiment 3 of the present invention;

FIG. 16 is a flow chart showing an operation of a map drawing unit included in a control unit of the map information processing device in accordance with Embodiment 3 of the present invention;

FIG. 17 is a flow chart showing an operation of a map drawing unit included in a control unit of a map information processing device in accordance with Embodiment 4 of the present invention;

FIG. 18 is a view showing an operation example in the map information processing device in accordance with Embodiment 4 of the present invention; and

FIG. 19 is a flow chart showing an operation of a map drawing unit included in a control unit of a map information processing device in accordance with Embodiment 5 of the present invention.

### EMBODIMENTS OF THE INVENTION

Hereafter, the preferred embodiments of the present invention will be explained in detail with reference to the drawings.

### Embodiment 1

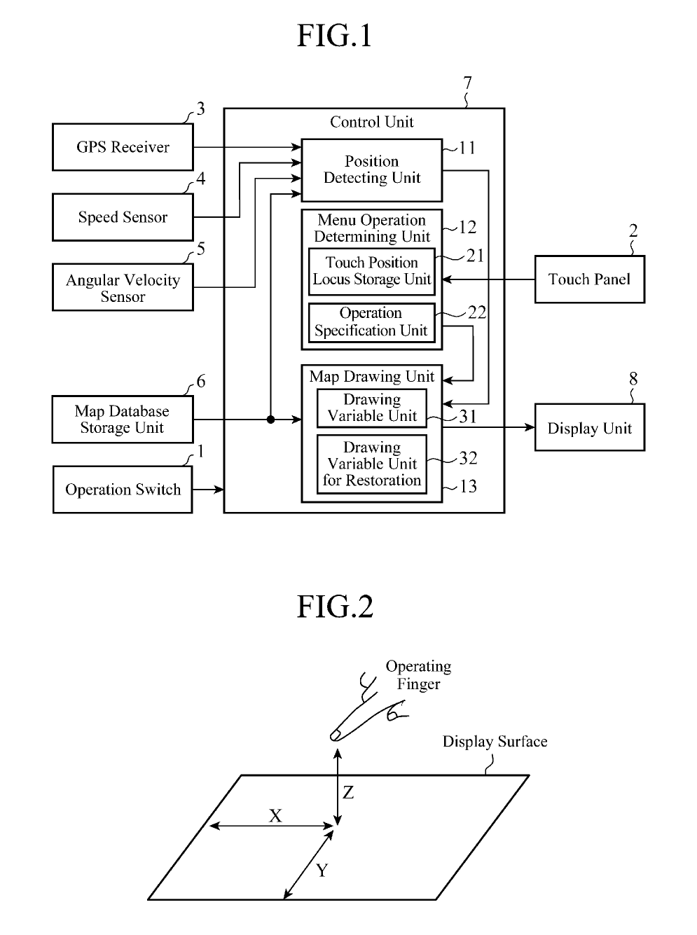

FIG. 1 is a block diagram showing the structure of a map information processing device in accordance with Embodiment 1 of the present invention. Hereafter, this map information processing device will be explained assuming that the map information processing device is applied to a navigation device mounted in a vehicle. The map information processing device is provided with operation switches 1, a touch panel 2, a GPS (Global Positioning System) receiver 3, a speed sensor 4, an angular velocity sensor 5, a map database storage unit 6, a control unit 7, and a display unit 8.

The operation switches 1 include various switches for enabling a user to operate the map information processing device. For example, the operation switches can consist of hard keys, a remote controller (remote control), or a voice recognition device. Operation data generated when the user operates these operation switches 1 is sent to the control unit 7.

The touch panel 2 corresponds to a three-dimensional input unit in accordance with the present invention, and consists of a three-dimensional touch panel mounted on a display surface of the display unit 8, for detecting the three-dimensional position of a finger with respect to this display surface. An object to be detected which is to be detected by the touch panel 2 is not limited to a finger, and can be another object which can be sensed by the touch panel 2. Three-dimensional position data indicating the three-dimensional position detected by this touch panel 2 is sent to the control unit 7.

The GPS receiver 3 detects the current position of a vehicle (not shown) in which the navigation device with which this map information processing device is applied is mounted according to GPS signals which the GPS receiver acquires by receiving radio waves transmitted from GPS satellites with an antenna (not shown). Current position data showing the current position of the vehicle detected by this GPS receiver 3 is sent to the control unit 7.

The speed sensor 4 detects the traveling speed of the vehicle according to a vehicle speed signal sent thereto from the vehicle. Speed data showing the traveling speed of the vehicle detected by this speed sensor 4 is sent to the control unit 7. The angular velocity sensor 5 detects a change of the traveling direction of the vehicle. Angular velocity data showing the change of the traveling direction of the vehicle detected by this angular velocity sensor 5 is sent to the control unit 7.

The map database storage unit 6 consists of, for example, a hard disk drive which uses a hard disk as a storage medium, and stores map data in which map components, such as roads, backgrounds, names, and landmarks, are described. Map data stored in this map database storage unit 6 is read by the control unit 7.

The control unit 7 consists of, for example, a microcomputer, and controls the whole of this map information processing device by transmitting and receiving data to and from the operation switches 1, the touch panel 2, the GPS receiver 3, the speed sensor 4, the angular velocity sensor 5, the map database storage unit 6, and the display unit 8. The details of this control unit 7 will be mentioned below.

The display unit 8 consists of, for example, an LCD (Liquid Crystal Display), and displays a map, the current position of the map information processing device on the map, etc. according to an image signal sent thereto from the control unit 7.

Next, the details of the control unit 7 will be explained. The control unit 7 is provided with a position detecting unit 11, a menu operation determining unit 12, and a map drawing unit 13. The position detecting unit 11 detects the position of the vehicle in which the navigation device to which this map information processing device is applied is mounted by using the current position data sent thereto from the GPS receiver 3, the vehicle speed data sent thereto from the speed sensor 4, and the angular velocity data sent thereto from the angular velocity sensor 5, and performs map matching by using this detected position and road data included in map data read from the map database storage unit 6 to detect the correct position of the vehicle. Position data showing the position of the vehicle detected by this position detecting unit 11 is sent to the map drawing unit 13.

The menu operation determining unit 12 determines the descriptions of a menu operation which is performed on the touch panel 2 by the user, for example, scrolling, enlargement or reduction of a screen, etc. according to the three-dimensional position of the user's finger shown by the three-dimensional position data sent thereto from the touch panel 2. Data showing the descriptions of the menu operation determined by this menu operation determining unit 12 is sent to the map drawing unit 13.

The map drawing unit 13 acquires the position data sent thereto from the position detecting unit 11 and also acquires map data needed for the menu operation shown by the data sent thereto from the menu operation determining unit 12 from the map database storage unit 6, and draws a map according to the position of the vehicle and the menu operation by using these position data and map data and sends an image signal indicating the map to the display unit 8. As a result, the map according to the position of the vehicle and the menu operation is displayed on the screen of the display unit 8.

The control unit 7 can also be constructed in such a way as to perform processes other than the above-mentioned process, e.g. a route searching process of determining a recommended route from a place of departure to a destination by using guidance information for route guiding, information about each location, etc., stored in the map database storage unit 6, a route guiding process of presenting guidance information to the user as the vehicle travels along the recommended route acquired through the route searching process, a location search process of acquiring information about a location satisfying a desired condition from the information about each location, and so on, which are carried out by the navigation device.

Further, the GPS receiver 3, the speed sensor 4, the angular velocity sensor 5, and the position detecting unit 11 in the control unit 7 can be removed from the map information processing device shown in FIG. 1 so that a map information processing device which displays a map independently on its position can be constructed.

Further, an image of various switches, instead of the operation switches 1, can be displayed on the display unit 8, and the map information processing device can be constructed in such away as to determine whether or not each of the various switches is pushed down by determining whether or not an image of the corresponding one of the various switches on the touch panel 2 is touched.

FIG. 2 is a view showing a relationship between the coordinates (X, Y, Z) showing the three-dimensional position of a finger which is detected by the touch panel 2 and the display surface of the display unit 8. With respect to the lower left corner of the display surface, X shows the position of the finger in a lateral direction of the display surface, Y shows the position of the finger in a longitudinal direction of the display surface, and Z shows the position of the finger in a direction perpendicular to the display surface.

The three-dimensional position of the finger detected by the touch panel 2 is referred to as the “touch position”. The touch panel 2 outputs touch position valid/invalid information indicating whether the touch position is valid or invalid in addition to the touch position. The touch position valid/invalid information indicates “valid” when the finger is located inside a sensitive area, whereas the touch position valid/invalid information indicates “invalid” when the finger is located outside the sensitive area.

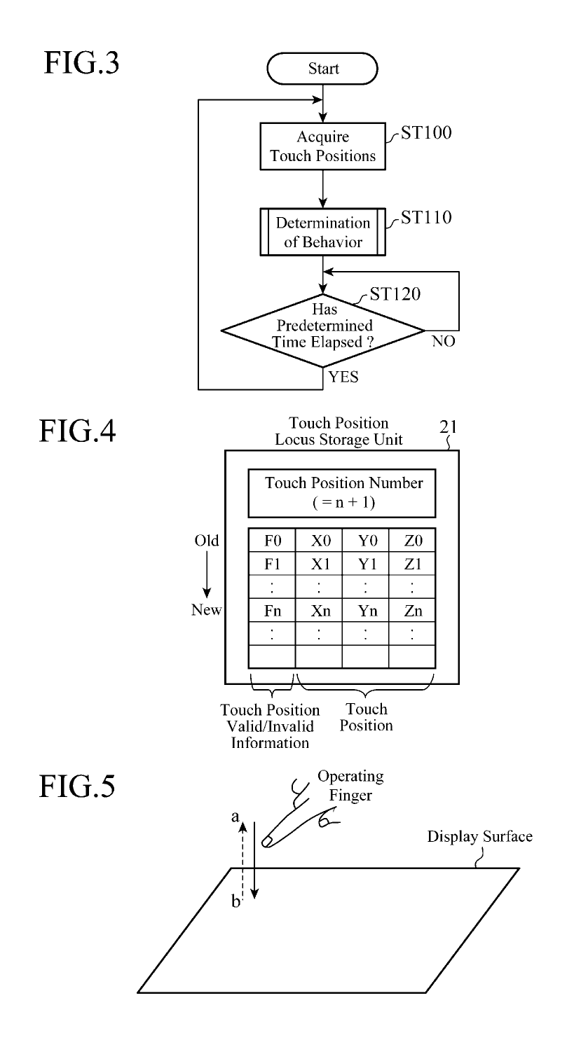

Next, the operation of the map information processing device in accordance with Embodiment 1 of the present invention will be explained. FIG. 3 is a flow chart showing the operation of the menu operation determining unit 12 of the control unit 7.

When the menu operation determining unit 12 starts a process, the touch position is acquired first (step ST100). More specifically, the menu operation determining unit 12 acquires the touch position of the user' s finger and the touch position valid/invalid information about the finger from the touch panel 2, and stores them in a touch position locus storage unit 21 disposed in the menu operation determining unit 12.

FIG. 4 is a view showing an example of the data stored in the touch position locus storage unit 21. The touch position locus storage unit 21 includes a table in which a touch position number showing the number of touch positions stored therein, and pairs of a touch position and touch position valid/invalid information are stored in chronological order. The contents stored in this touch position locus storage unit 21 show the locus of the moving touch position.

Behavior determining processing is then carried out (step ST110). More specifically, the menu operation determining unit 12 determines the operation corresponding to the behavior of the user's finger according to the locus of the moving touch position shown by the contents of the touch position locus storage unit 21, and stores the determination result in an operation specification unit 22 disposed in the menu operation determining unit 12.

A code showing a non-operation, an enlarging or reducing operation, a scrolling operation, a confirmation operation (or an accept operation), or a non-confirmation operation (or a reject operation) is stored in the operation specification unit 22 as the determination result. For example, the following values: 0, 1, 2, 3, 4 and 5 are provided, as the code, for a non-operation, an enlarging or reducing operation, a scrolling operation, a confirmation operation, or a non-confirmation operation, respectively. When the determination result shows scrolling, a scroll direction, a scroll speed, and an average of the Z coordinate are further stored in the operation specification unit.

FIG. 5 is a view showing operation examples in a case of enlarging or reducing a map. When the user desires to enlarge a map, he or she moves his or her finger in a direction of a solid line arrow (a direction from a to b) to bring the finger close to the display surface of the display unit 8. In contrast, when the user desires to reduce a map, he or she moves his or her finger in a direction of a dashed line arrow (a direction from b to a) to move the finger away from the display surface of the display unit 8.

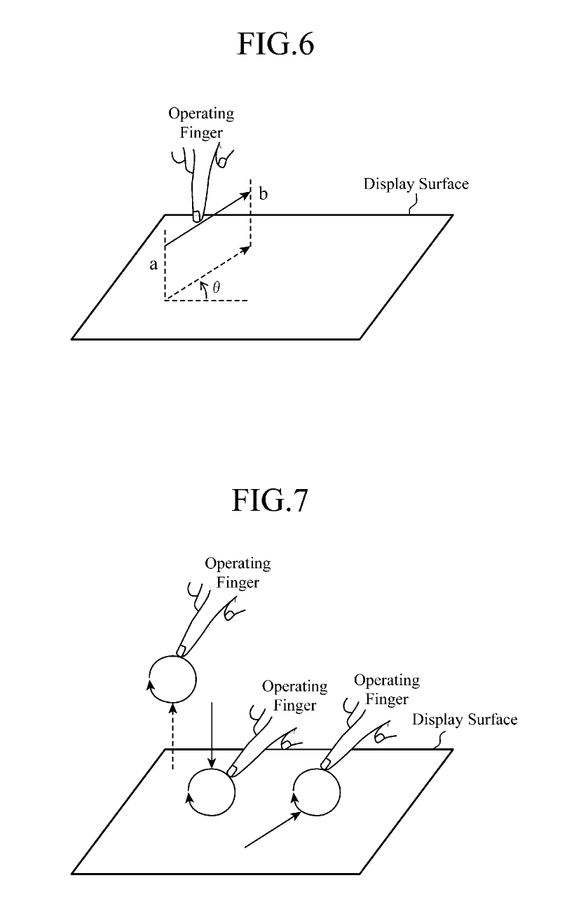

FIG. 6 is a view showing an operation example in a case of scrolling a map. When the user desires to scroll a map in a direction of an angle θ on the display surface of the display unit 8, he or she moves his or her finger in a direction of a solid line arrow (a direction from a to b). When the user's finger reaches b, and the user further desires to continue the scrolling, he or she returns his or her finger in a direction opposite to the direction of the solid line arrow (a direction from b to a), and then moves the finger in the direction of the solid line arrow (the direction from a to b) again. By repeating this operation, the user can cause the map information processing device to scroll a map any distance. In the figure, a dashed line arrow is the projection of the solid line arrow onto the display surface.

FIG. 7 is a view showing operation examples in a case in which the user confirms (or accepts) the result of his or her previous operation. When the user desires to confirm a display state which has occurred after he or she enlarges, reduces or scrolls a map, the user moves his or her finger in such a way as to draw a circle with the finger after moving the finger in such a way as to cause the map information processing device to enlarge, reduce or scroll the map. A confirmation operation is not limited to an operation of moving a finger in such a way as to draw a circle with the finger, and can be an arbitrary finger movement as long as this movement differs from movements of the user's finger each for causing the map information processing device to enlarge, reduce or scroll a map.

When no finger exists within the sensitive area of the touch panel 2, the map information processing device determines that the user has not performed any operation and hence the user operation is a “non-operation”. Particularly, when the user moves his or her finger toward outside the sensitive area without performing a confirmation operation after performing an operation of enlarging, reducing or scrolling a map, the map information processing device cancels the operation of enlarging, reducing or scrolling a map which the user has performed. Further, when the user's finger is not moving, the map information processing device determines that the user operation is a “non-confirmation” one if the user performs an operation other than an operation of enlarging, reducing or scrolling a map and a confirmation operation.

The map information processing device then checks to see whether a predetermined time has elapsed (step ST120). When, in this step ST120, determining that the predetermined time has not elapsed, the map information processing device enters a standby state in which the map information processing device repeatedly carries out the process of this step ST120. When determining that the predetermined time has elapsed in the standby state in which the map information processing device repeatedly carries out the process of this step ST120, the map information processing device returns the sequence to step ST100 and repeats the above-mentioned processing.

Through the above-mentioned operation, the map information processing device stores the touch position and the touch position valid/invalid information which the map information processing device has acquired at predetermined time intervals in the touch position locus storage unit 21 in order that the map information processing device has acquired the touch position and the touch position valid/invalid information, and also determines the operation which has been performed on the touch panel by the user with the locus of the moving touch position, stores the determination result in the operation specification unit 22, and sends the contents stored in this operation specification unit 22 to the map drawing unit 13.

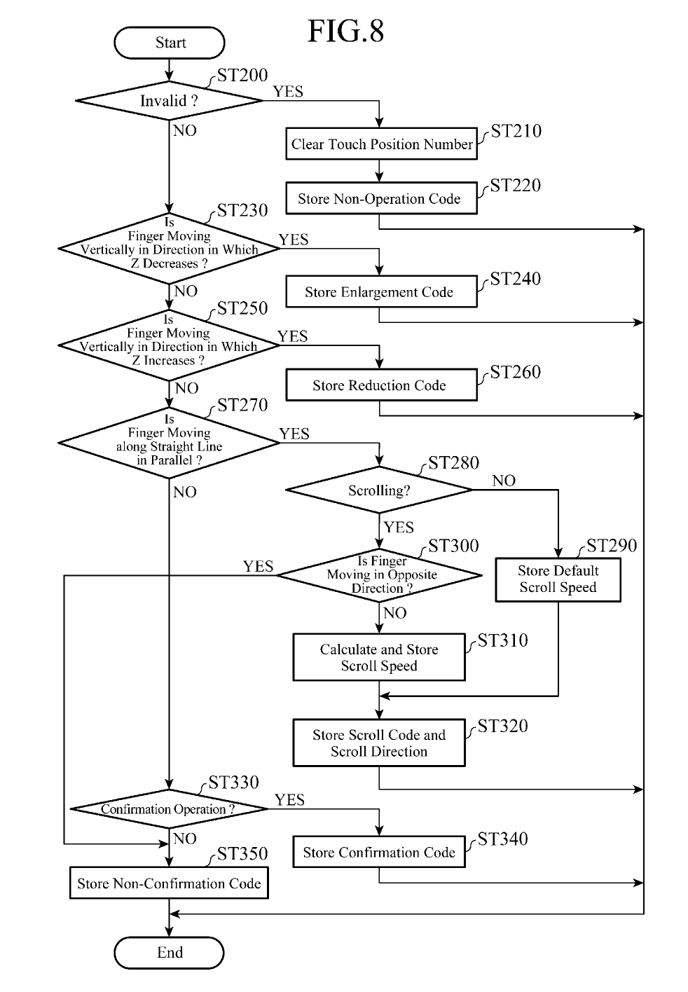

Next, the details of the behavior determining processing carried out in step ST110 of FIG. 3 will be explained with reference to a flow chart shown in FIG. 8.

In the behavior determining processing, whether or not the touch position is invalid is checked to see first (step ST200). More specifically, the menu operation determining unit 12 checks to see whether the newest touch position valid/invalid information stored in the touch position locus storage unit 21 shows invalidity. When, in this step ST200, determining that the newest touch position valid/invalid information shows invalidity, the map information processing device recognizes that the user's fingers are located outside the sensitive area of the touch panel 2 and no touch operation has been performed, and advances the sequence to step ST210.

The touch position number is cleared in step ST210. More specifically, the menu operation determining unit 12 clears the touch position number stored in the touch position locus storage unit 21 to “0”. After that, the touch position valid/invalid information and the touch position are stored sequentially from the head of the table of the touch position locus storage unit 21 shown in FIG. 4. A non-operation code is then stored (step ST220). More specifically, the menu operation determining unit 12 stores a non-operation code showing invalidity in the operation specification unit 22. Then, the behavior determining processing is ended.

When it is determined, in above-mentioned step ST200, that the newest touch position valid/invalid information does not show invalidity, whether the value of the Z coordinate is decreasing because of a vertical movement of the user's finger is then checked to see (step ST230). More specifically, the menu operation determining unit 12 traces the touch positions stored in the touch position locus storage unit 21 in reverse chronological order, from the most recent one to older ones, to check to see whether or not the variations in the X and Y coordinates are small, and whether or not the value of the Z coordinate is varying in a direction in which the value decreases.

When it is determined, in this step ST230, that the value of the Z coordinate is decreasing because of a vertical movement of the user's finger, it is recognized that the user is moving his or her finger from a to b, as shown by a solid line of FIG. 5, to perform an operation of enlarging a map, and an enlargement code is then stored in the operation specification unit (step ST240). More specifically, the menu operation determining unit 12 stores the enlargement code showing enlargement of the screen in the operation specification unit 22. Then, the behavior determining processing is ended.

In contrast, when it is determined, in above-mentioned step ST230, that the value of the Z coordinate is not decreasing because of a vertical movement of the user's finger, whether or not the value of the Z coordinate is increasing because of a vertical movement of the user's finger is then checked to see (step ST250). More specifically, the menu operation determining unit 12 traces the touch positions stored in the touch position locus storage unit 21 in reverse chronological order, from the most recent one to older ones to, check to see whether or not the variations in the X and Y coordinates are small, and whether or not the value of the Z coordinate is varying in a direction in which the value increases.

When it is determined, in this step ST250, that the value of the Z coordinate is increasing because of a vertical movement of the user's finger, it is recognized that the user is moving his or her finger from a to b, as shown by a dashed line of FIG. 5, to perform an operation of reducing a map, and a reduction code is then stored in the operation specification unit (step ST260). More specifically, the menu operation determining unit 12 stores the reduction code showing reduction of the screen in the operation specification unit 22. Then, the behavior determining processing is ended.

In contrast, when it is determined, in above-mentioned step ST250, that the value of the Z coordinate is not increasing because of a vertical movement of the user's finger, whether or not the user's finger is moving along a straight line in parallel to the display surface is then checked to see (step ST270). More specifically, the menu operation determining unit 12 traces the touch positions stored in the touch position locus storage unit 21 in reverse chronological order, from the most recent one to older ones, to check to see whether or not the variations in the Z coordinate are small, and whether or not the X and Y coordinates are varying linearly in a certain direction with the variations in each of the X and Y coordinates falling within a specified error. In this case, the menu operation determining unit 12 determines an angle with respect to a certain direction (e.g. θ shown in FIG. 6), and temporarily stores the angle in a memory not shown as a temporary scroll direction. The menu operation determining unit also calculates the average of the Z coordinate during the time period during which the user's finger has moved linearly, and temporarily stores the average in the memory not shown as a value for scroll speed determination.

When it is determined in this step ST270 that the user's finger is moving along a straight line in parallel to the display surface, whether or not the screen is being scrolled is then checked to see (step ST280). More specifically, the menu operation determining unit 12 checks to see whether or not the code stored in the operation specification unit 22 is a scroll one showing scrolling of the screen.

When it is determined in this step ST280 that the screen is not being scrolled, that is, that the code stored in the operation specification unit 22 is not the scroll one, it is recognized that scrolling has been started and a default scroll speed is stored (step ST290). More specifically, the menu operation determining unit 12 recognizes that the user operation is a first-time scrolling one and stores the scroll speed which is defined as the default one in the operation specification unit 22, and also stores the average of the Z coordinate which is temporarily stored in the memory in step ST270 in the operation specification unit 22. After that, the sequence is advanced to step ST320.

In contrast, when it is determined, in above-mentioned step ST280, that the screen is being scrolled, that is, that the code stored in the operation specification unit 22 is the scroll one, it is recognized that the screen is being scrolled, and whether or not the scroll direction is an opposite direction is then checked to see (step ST300). More specifically, the menu operation determining unit 12 compares the scroll direction stored in the operation specification unit 22 with the temporary scroll direction temporarily stored in the memory in step ST270 to check to see whether or not they are opposite to each other.

When it is determined, in this step ST300, that the scroll direction is an opposite direction, that is, the scroll direction stored in the operation specification unit 22 and the temporary scroll direction are opposite to each other, it is recognized that the user's finger is being returned in the opposite direction of the solid line arrow shown in FIG. 6 (the direction from b to a) in order to further scroll the map in the same direction, and the sequence is advanced to step ST350.

In contrast, when it is determined, in step ST300, that the scroll direction is not an opposite direction, that is, the scroll direction stored in the operation specification unit 22 and the temporary scroll direction are the same as each other, it is recognized that further scrolling in the same direction is commanded or scrolling in a new direction is commanded, and a scroll speed is then calculated and stored (step ST310). More specifically, the menu operation determining unit 12 compares the average of the Z coordinate stored in the operation specification unit 22 with the average of the Z coordinate temporarily stored in the memory in step ST270, and, when the average of the Z coordinate increases, increases the scroll speed stored in the operation specification unit 22 by a predetermined value, whereas when the average of the Z coordinate decreases, the menu operation determining unit decreases the scroll speed stored in the operation specification unit by a predetermined value. Further, the menu operation determining unit 12 stores the average of the Z coordinate temporarily stored in the memory in step ST270 in the operation specification unit 22. After that, the sequence is advanced to step ST320.

The scroll code and the scroll direction are stored in step ST320. More specifically, the menu operation determining unit 12 stores the code showing scrolling in the operation specification unit 22, and also stores the temporary scroll direction temporarily stored in the memory in step ST270 in the operation specification unit 22 as a scroll direction. Then, the behavior determining processing is ended.

When it is determined, in above-mentioned step ST270, that the user's finger is not moving along a straight line in parallel to the display surface, whether or not a confirmation operation has been performed is then checked to see (step ST330). More specifically, the menu operation determining unit 12 traces the touch positions stored in the touch position locus storage unit 21 in reverse chronological order, from the most recent one to older ones, to check to see whether or not the variations in the Z coordinate are small, and whether or not the X and Y coordinates show a circular locus with the variations in each of the X and Y coordinates falling within a specified error.

When it is determined, in this step ST330, that a confirmation operation has been performed, it is recognized that the user has moved his or her finger in such away as shown in FIG. 7 to command the map information processing device to end the map operation, and a confirmation code is stored after the display scale and the display center coordinates are set to the current settings (step ST340). More specifically, the menu operation determining unit 12 stores the confirmation code indicating confirmation in the operation specification unit 22. After that, the behavior determining processing is ended.

In contrast, when it is determined, in step ST330, that the user operation is not a confirmation one, the sequence is advanced to step ST350. A non-confirmation code is stored in step ST350. More specifically, the menu operation determining unit 12 determines that the user's fingers have been stopped or no operation associated with enlargement, reduction or scrolling of a map, or confirmation is carried out, and stores the non-confirmation code indicating non-confirmation in the operation specification unit 22. After that, the behavior determining processing is ended.

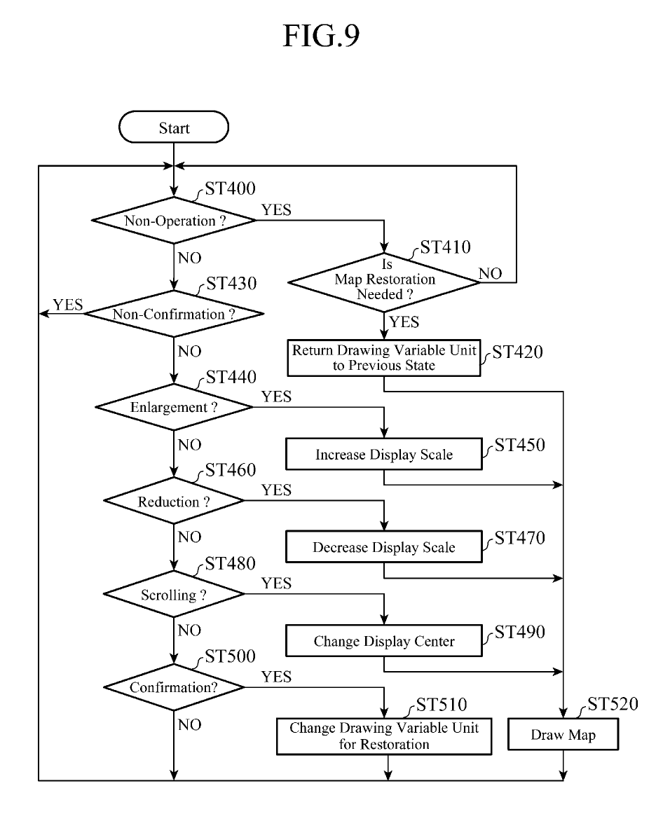

FIG. 9 is a flow chart showing the operation of the map drawing unit 13 of the control unit 7. The map drawing unit 13 operates in parallel with the above-mentioned operation of the menu operation determining unit 12, and draws a map in the behavior determining processing of above-mentioned step ST110 according to the code stored in the operation specification unit 22.

In advance of the map drawing, the display scale of the map to be displayed on the display unit 8 and the display center coordinates which are the map coordinates of a point corresponding to the center of the display surface of the display unit 8 are stored in a drawing variable unit 31 disposed in the map drawing unit 13. As the display center coordinates, the latitude and longitude of the display center point are used, for example. Further, a map display scale and display center coordinates required to return the map display to its original one is stored in a drawing variable unit 32 for restoration disposed in the map drawing unit 13.

In an initial state, a predetermined display scale and predetermined display center coordinates are stored in the drawing variable unit 31, and a map is drawn with this stored display scale in such a way that the display center coordinates are located at the center of the display surface. Further, the same display scale and the same display center coordinates as those stored in the drawing variable unit 31 are also stored in the drawing variable unit 32 for restoration. Then, the following process is carried out.

When starting the process, the map drawing unit 13 checks to see whether or not the user operation is a non-operation first (step ST400). More specifically, the map drawing unit 13 refers to the operation specification unit 22 to check to see whether or not the code stored in the operation specification unit is the non-operation one. When it is determined, in this step ST400, that the user operation is a non-operation, whether or not there is necessity to restore the map is then checked to see (step ST410). More specifically, the map drawing unit 13 compares the contents of the drawing variable unit 31 with those of the drawing variable unit 32 for restoration, and, when they are not the same as each other, recognizes that the display scale or the display center coordinates stored in the drawing variable unit 31 varies because enlargement, reduction or scrolling of the map has been carried out until then, and a non-operation is selected after enlargement, reduction or scrolling of the map has been performed, and then determines that there is a necessity to restore the currently displayed map to the state in which the map was previously placed before the enlargement, reduction or scrolling operation has been performed on the map in order to cancel the enlargement, reduction or scrolling operation. In contrast, the map drawing unit 13 compares the contents of the drawing variable unit 31 with those of the drawing variable unit 32 for restoration, and, when they are the same as each other, determines that a non-operation has been selected or a non-operation is selected after detecting the user's confirmation operation, and therefore there is no necessity to restore the currently displayed map to the state in which the map was previously placed before the operation has been performed on the map.

When it is determined, in above-mentioned step ST410, that there is no necessity to restore the currently displayed map to the previous state, the sequence is returned to step ST400 and the above-mentioned processing is repeated. In contrast, when it is determined, in step ST410, that there is necessity to restore the currently displayed map to the previous state, the drawing variable unit 31 is then returned to its previous state (step ST420). More specifically, the map drawing unit 13 reads the display scale and the display center coordinates from the drawing variable unit 32 for restoration, and stores the display scale and the display center coordinates in the drawing variable unit 31. Because the display scale and the display center coordinates which were set to the map information processing device before the operation has been performed are stored in the drawing variable unit 32 for restoration, the display scale and the display center coordinates required for drawing of the previous map which was displayed before the operation which is a target for restoration has been performed are stored in the drawing variable unit 31 through this process. After that, the sequence is advanced to step ST520.

When it is determined, in above-mentioned step ST400, that the user operation is not a non-operation one, whether or not the user operation is a non-confirmation one is then checked to see (step ST430). More specifically, the map drawing unit 13 refers to the operation specification unit 22 to check to see whether or not the code stored in the operation specification unit is the non-confirmation one. When it is determined, in this step ST430, that the user operation is a non-confirmation one, the sequence is returned to step ST400 and the above-mentioned processing is repeated.

In contrast, when it is determined, in step ST430, that the user operation is not a non-confirmation one, whether or not the user operation is an enlarging one is then checked to see (step ST440). More specifically, the map drawing unit 13 refers to the operation specification unit 22 to check to see whether or not the code stored in the operation specification unit is the enlargement one. When it is determined, in this step ST440, that the user operation is an enlarging one, the display scale is increased (step ST450). More specifically, the map drawing unit 13 increases the display scale stored in the drawing variable unit 31 by a predetermined value. After that, the sequence is advanced to step ST520. When the display scale exceeds a predetermined upper limit as a result of the increase in this step ST450, the map drawing unit stores the upper limit in the drawing variable unit 31.

In contrast, when it is determined, in above-mentioned step ST440, that the user operation is not an enlarging one, whether or not the user operation is a reducing one is then checked to see (step ST460). More specifically, the map drawing unit 13 refers to the operation specification unit 22 to check to see whether the code stored in the operation specification unit is the reduction one. When it is determined, in this step ST460, that the user operation is a reducing one, the display scale is decreased (step ST470). More specifically, the map drawing unit 13 decreases the display scale stored in the drawing variable unit 31 by a predetermined value. After that, the sequence is advanced to step ST520. When the display scale exceeds a predetermined lower limit as a result of the decrease in this step ST470, the map drawing unit stores the lower limit in the drawing variable unit 31.

In contrast, when it is determined, in step ST460, that the user operation is not a reducing one, whether or not the user operation is a scrolling one is then checked to see (step ST480). More specifically, the map drawing unit 13 refers to the operation specification unit 22 to check to see whether the code stored in the operation specification unit is the scroll one. When it is determined, in this step ST480, that the user operation is a scrolling one, the display center is changed (step ST490). More specifically, the map drawing unit 13 calculates an amount of change in the display center coordinates required to scroll the map currently being displayed a predetermined distance from the scroll direction and the scroll speed which are stored in the operation specification unit 22, and the display scale stored in the drawing variable unit 31 to change the display center coordinates stored in the drawing variable unit 31 by the amount of change which is determined thereby. After that, the sequence is advanced to step ST520.

In contrast, when it is determined, in step ST480, that the user operation is not a scrolling one, whether or not the user operation is a confirmation one is then checked to see (step ST500). More specifically, the map drawing unit 13 refers to the operation specification unit 22 to check to see whether the code stored in the operation specification unit is the confirmation one. When it is determined, in this step ST500, that the user operation is a confirmation one, the contents of the drawing variable unit 32 for restoration are changed (step ST510). More specifically, because the map has changed to an enlarged, reduced, or scrolled state which the user desires, and there is no necessity to restore the map to the state in which the map was previously placed before the operation has been performed on the map, the map drawing unit 13 reads the display scale and the display center coordinates from the drawing variable unit 31, and stores the display scale and the display center coordinates in the drawing variable unit 32 for restoration. After that, the sequence is returned to step ST400, and the above-mentioned processing is then repeated. Further, also when it is determined, in above-mentioned step ST500, that the user operation is not a confirmation one, the sequence is returned to step ST400, and the above-mentioned processing is then repeated.

Map drawing is performed in step ST520. More specifically, the map drawing unit 13 acquires needed map data which has the display scale stored in the drawing variable unit 31 and which make the map coordinates of a point corresponding to the center of the display surface of the display unit 8 be equal to the display center coordinates stored in the drawing variable unit 31 from the map database storage unit 6, and performs map drawing. After that, the sequence is returned to step ST400, and the above-mentioned processing is then repeated.

As previously explained, the map information processing device in accordance with Embodiment 1 of the present invention enables the user to cause the map information processing device to change the scale of a map displayed thereon by performing a simple, intuitively intelligible operation. Further, because the map information processing device scrolls the map only when detecting a parallel movement of the user's finger along a straight line, and only changes the scale of the map in such a way that the map has the same display center as the original display position except when detecting a parallel movement of the user's finger along a straight line, the map information processing device can change the scale without scrolling the map even if the user's finger shakes a little when performing an operation of changing the scale. As a result, the map information processing device enables the user to intuitively and easily perform an operation of changing the display of the map thereon while maintaining the viewability of the map.

Further, because the map information processing device is constructed in such a way as to enlarge the map when a finger or an object which is detected by the touch panel 2 gets close to the display surface, and reduce the map when the finger or the object which is detected by the touch panel 2 moves away from the display surface, the map information processing device matches a human being feeling that as the user gets closer to the map, the map looks larger, and enables the user to cause the map information processing device to change the scale of the map without having a feeling that something is abnormal. Further, the map information processing device is constructed in such a way as to display the map having the original scale when the finger or the object moves away from the touch panel 2 towards a distance at which it cannot be detected by the touch panel 2, the map information processing device enables the user to cancel a change of the scale of the map displayed thereon by performing such a simple operation.

Further, because the map information processing device enables the user to perform a scale changing operation and a scrolling operation thereon nearly simultaneously by performing simple operations using a three-dimensional input, the user can simultaneously cause the map information processing device to perform a change of the scale of the map displayed on the map information processing device and scrolling of the map. In addition, the user is enabled to cancel a scale change or scrolling, and perform a confirmation operation by simply performing an intuitive operation without touching the screen repeatedly and pushing down buttons. Further, the user is enabled to cause the map information processing device to simultaneously scroll the map and change the scroll speed.

### Embodiment 2

The map information processing device in accordance with above-mentioned Embodiment 1 determines whether to enlarge or reduce a map or whether to increase or decrease the scroll speed according to a relative change in the distance from the touch panel 2 to the user's finger (i.e. according to whether or not the user's finger is getting close to or moving away from the touch panel after the user operated the touch panel previously). In contrast, a map information processing device in accordance with Embodiment 2 of the present invention sets up an absolute reference and fixedly determines a drawing scale and a scroll speed according to the vertical position of the user's finger above the touch panel, instead of the determination based on a relative change in the distance from the touch panel to the user's finger. Because the map information processing device in accordance with this embodiment has the same basic structure as that in accordance with Embodiment 1, a portion which is different from the map information processing device in accordance with Embodiment 1 will be explained hereafter.

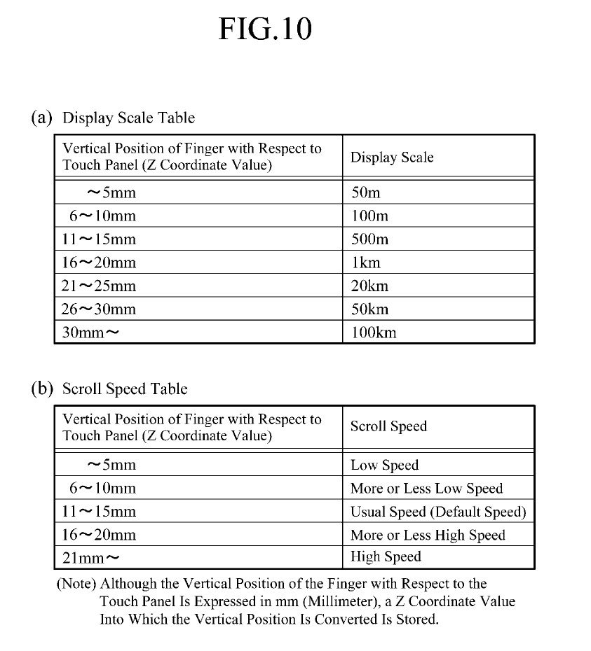

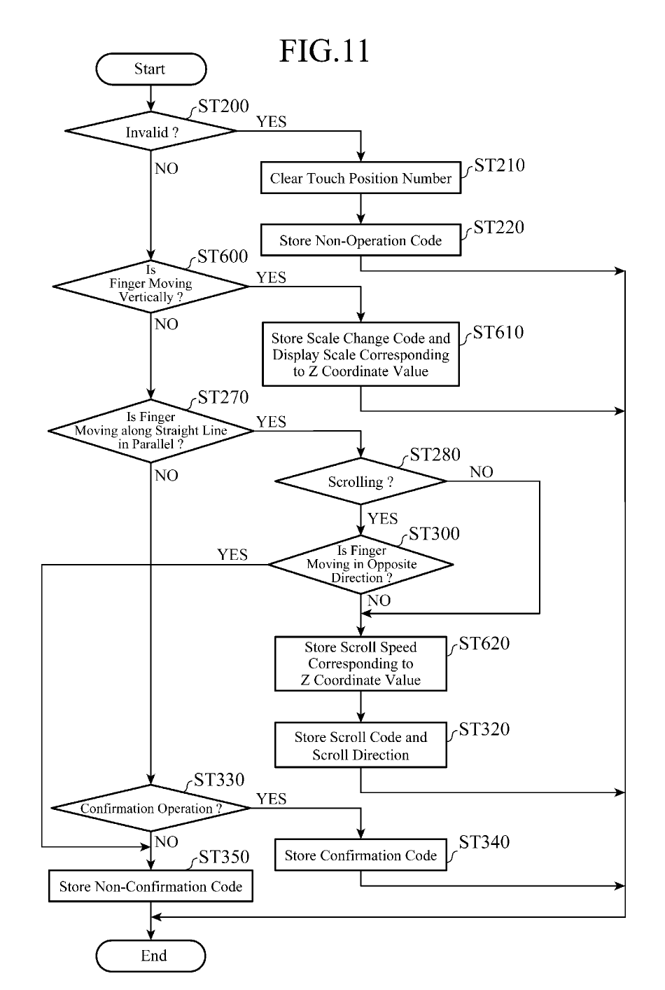

FIG. 10(a) shows an example of a display scale table which is used to define a fixed drawing scale, and FIG. 10(b) shows an example of a scroll speed table which is used to define a fixed scroll speed. These display scale table and scroll speed table are stored in a not-shown memory of a control unit 7, and are constructed in such a way that they can be referred to at any time.

Behaviors determined in step ST110 of FIG. 3 are a non-operation, a scale changing operation, a scrolling operation, a confirmation operation, and a non-confirmation operation. A method of determining whether a non-operation, a scrolling operation, or a confirmation operation has been performed, and a process which the map information processing device performs after the determination are the same as those in the case of the map information processing device in accordance with above-mentioned Embodiment 1.

The map information processing device determines that a “scale change” has been performed when determining that an enlarging or reducing operation as shown in the map information processing device in accordance with Embodiment 1 has been performed. At this time, the map information processing device also stores the display scale in an operation specification unit 22. The map information processing device determines that a confirmation operation has been performed when determining that the user's fingers have been stopped or no operation associated with enlargement, reduction or scrolling of a map, or confirmation has been carried out.

Next, the details of behavior determining processing carried out in step ST110 of FIG. 3 will be explained by making reference to a flow chart shown in FIG. 11. In the flow chart shown in FIG. 11, steps in which the same processes as those of the behavior determining processing carried out by the map information processing device in accordance with Embodiment 1 shown in the flow chart of FIG. 8 are performed are designated by the same reference characters as those shown in FIG. 8, and the explanation of the processes will be simplified hereafter.

In the behavior determining processing, whether or not the user operation is invalid is checked to see first (step ST200). When it is determined, in this step ST200, that the user operation is invalid, a touch position number is then cleared (step ST210). A non-operation code is then stored (step ST220). After that, the behavior determining processing is ended.

When it is determined, in above-mentioned step ST200, that the user operation is not invalid, whether or not the user's finger is moving vertically is then checked to see (step ST600). More specifically, a menu operation determining unit 12 traces the touch positions stored in a touch position locus storage unit 21 in reverse chronological order, from the most recent one to older ones, to check to see whether or not the variations in the X and Y coordinates are small, and whether or not the Z coordinate is varying in a direction in which the Z coordinate increases or decreases. In this case, the most recent Z coordinate is temporarily stored in a not-shown memory of the control unit 7.

When it is determined, in this step ST600, that the user's finger is moving vertically, it is recognized that the user is moving the user's finger, as shown by a solid line or a dashed line of FIG. 5, to perform an operation of changing the display scale of a map, and a scale change code and a display scale corresponding to the Z coordinate is stored (step ST610). More specifically, the menu operation determining unit 12 stores the scale change code indicating the scale change in the operation specification unit 22, and also refers to the display scale table to store the display scale corresponding to the Z coordinate temporarily stored in the memory of the control unit 7 in step ST600 in the operation specification unit 22. After that, the behavior determining processing is ended.

When it is determined, in above-mentioned step ST600, that the user's finger is not moving vertically, whether the user's finger is moving along a straight line in parallel to a display surface is then checked to see (step ST270). When it is determined in this step ST270 that the user's finger is moving along a straight line in parallel to the display surface, whether the screen is being scrolled is then checked to see (step ST280). When it is determined, in this step ST280, that the screen is not being scrolled, the sequence is advanced to step ST620.

In contrast, when it is determined, in step ST280, that the screen is being scrolled, whether or not the scroll direction is an opposite direction is then checked to see (step ST300). When it is determined, in this step ST300, that the scroll direction is an opposite direction, the sequence is advanced to step ST350. In contrast, when it is determined, in step ST300, that the scroll direction is not an opposite direction, the sequence is advanced to step ST620.

In step ST620, a scroll speed corresponding to the Z coordinate is stored. More specifically, the menu operation determining unit 12 refers to the scroll speed table stored in the not-shown memory of the control unit 7, and stores the scroll speed corresponding to the average of the Z coordinate which is temporarily stored in the memory of the control unit 7 in step ST270 in the operation specification unit 22. The scroll code and the scroll direction are then stored (step ST320). After that, the behavior determining processing is ended.

When it is determined, in above-mentioned step ST270, that the user's finger is not moving along a straight line in parallel to the display surface, whether or not the user operation is a confirmation one is then checked to see (step ST330). When it is determined, in this step ST330, that the user operation is a confirmation one, a confirmation code is stored (step ST340). After that, the behavior determining processing is ended. When it is determined, in above-mentioned step ST330, that is the user operation is not a confirmation one, the sequence is advanced to step ST350. Anon-confirmation code is stored in step ST350. After that, the behavior determining processing is ended.

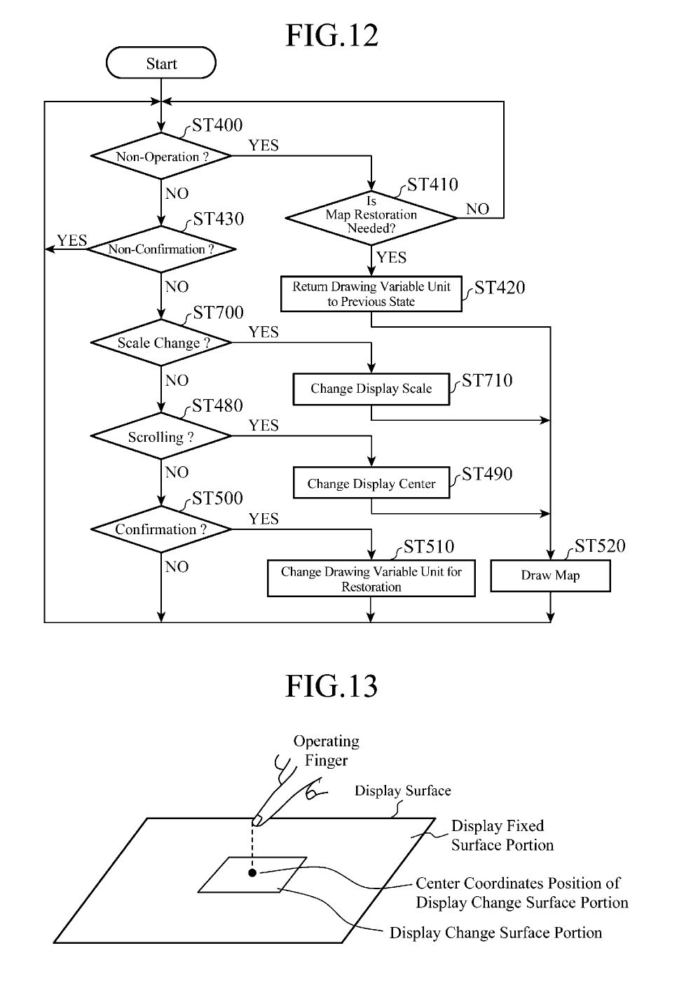

FIG. 12 is a flow chart showing the operation of a map drawing unit 13 of the control unit 7. In the flow chart shown in FIG. 12, steps in which the same processes as those carried out by the map information processing device in accordance with

Embodiment 1 shown in the flow chart of FIG. 9 are performed are designated by the same reference characters as those shown in FIG. 9, and the explanation of the processes will be simplified hereafter.

First, whether or not the user operation is a non-operation is checked to see (step ST400). When it is determined, in this step ST400, that the user operation is a non-operation, whether or not there is a necessity to restore the map is then checked to see (step ST410). When it is determined, in this step ST410, that there is no necessity to restore the map, the sequence is returned to step ST400 and the above-mentioned processing is repeated. In contrast, when it is determined, in step ST410, that there is a necessity to restore the map, a drawing variable unit 31 is then returned to its previous state (step ST420). After that, the sequence is advanced to step ST520.

When it is determined, in above-mentioned step ST400, that the user operation is not a non-operation, whether or not the user operation is a non-confirmation one is then checked to see (step ST430). When it is determined, in this step ST430, that the user operation is a non-confirmation one, the sequence is returned to step ST400 and the above-mentioned processing is repeated.

In contrast, when it is determined, in step ST430, that the user operation is not a non-confirmation one, whether or not the user operation is a scale changing one is then checked to see (step ST700). More specifically, the map drawing unit 13 refers to the operation specification unit 22 to check to see whether the code stored in the operation specification unit is a scale change one. When it is determined, in this step ST700, that the user operation is a scale changing one, the display scale is changed (step ST710). More specifically, the map drawing unit 13 overwrites the display scale stored in the drawing variable unit 31 with the display scale stored in the operation specification unit 22. After that, the sequence is advanced to step ST520.

When it is determined, in above-mentioned step ST700, that the user operation is not a scale changing one, whether or not the user operation is a scrolling one is then checked to see (step ST480). When it is determined, in this step ST480, that the user operation is a scrolling one, the display center is changed (step ST490). After that, the sequence is advanced to step ST520.

When it is determined, in above-mentioned step ST480, that the user operation is not a scrolling one, whether or not the user operation is a confirmation one is then checked to see (step ST500). When it is determined, in this step ST500, that the user operation is a confirmation one, the contents of a drawing variable unit 32 for restoration are changed (step ST510). After that, the sequence is returned to step ST400, and the above-mentioned processing is repeated. Further, also when it is determined, in above-mentioned step ST500, that the user operation is not a confirmation one, the sequence is returned to step ST400, and the above-mentioned processing is repeated. Map drawing is performed in step ST520. After that, the sequence is returned to step ST400, and the above-mentioned processing is repeated.

As previously explained, because the map information processing device in accordance with Embodiment 2 of the present invention is constructed in such a way as to fixedly determine a scale and a scroll speed according to the vertical position of the user's finger above the touch panel, when a scale and a scroll speed to which the user desires to cause the map information processing device to switch are predetermined, the map information processing device enables the user to move the user's finger directly to a position corresponding to the scale and the scroll speed to cause the map information processing device to quickly and easily switch to the desired scale and the desired scroll speed.

### Embodiment 3

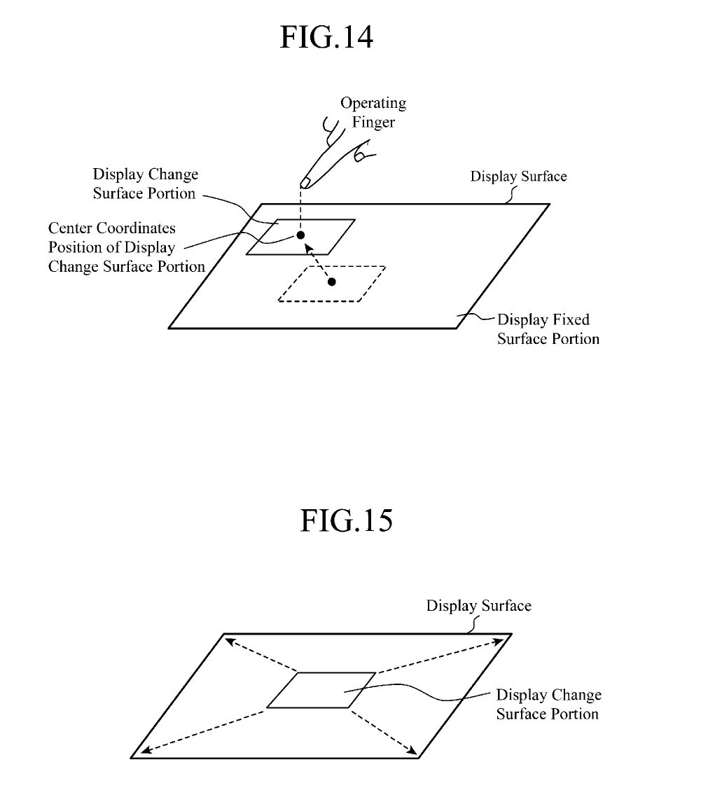

A map information processing device in accordance with Embodiment 3 of the present invention produces a fixed screen without allowing the user to scroll the screen, and enables application of enlarging and reducing operations of the map information processing device in accordance with Embodiment 1 only to a screen area in the vicinity of a point to which the user brings his or her finger close to draw a map. FIGS. 13 and 14 are views showing operation examples in the map information processing device in accordance with Embodiment 3, and show that, when the user moves his or her operating finger towards an upper left corner of the screen in a state shown in FIG. 13, only a display change surface portion is moved while the display of a display fixed surface portion is not changed, as shown in FIG. 4. Hereafter, a portion different from the map information processing device in accordance with Embodiment 1 will be explained.

A display scale and the display center coordinates of the display change surface portion are stored in a drawing variable unit 31 disposed in a map drawing unit 13. In an initial state, a predetermined display scale and predetermined display center coordinates are stored. A display scale and the display center coordinates of the display fixed surface portion are stored in a drawing variable unit 32 for restoration. In an initial state, a predetermined display scale and predetermined display center coordinates are stored.

Behaviors determined in step ST110 of FIG. 3 are a non-operation, an enlarging operation, a reducing operation, a translating operation, a confirmation operation, and a non-confirmation operation. A method of determining whether a non-operation, an enlarging operation, a reducing operation, or a confirmation operation has been performed, and a process which the map information processing device performs after the determination are the same as those in the case of the map information processing device in accordance with above-mentioned Embodiment 1.

When tracing touch positions stored in a touch position locus storage unit 21 in reverse chronological order, from the most recent one to older ones, and then determining that the X and Y coordinates have varied, the map information processing device that the user operation is a “translating” operation. In order to change the scale of a map of a neighboring area at a fixed distance or less from the point having the most recent X and Y coordinates at this time to draw the map, the map information processing device stores the most recent X and Y coordinates in an operation specification unit 22. In this case, whether the Z coordinate has varied is insignificant. The map information processing device determines that the user operation is a “non-confirmation” one when determining that the user's fingers have been stopped or no operation associated with enlargement, reduction, scrolling or translation of a map, or confirmation has been carried out.

Next, the operation of the map information processing device in accordance with this Embodiment 3 will be explained. Because behavior determining processing carried out by this map information processing device is the same as that carried out by the map information processing device in accordance with Embodiment 1 shown in the flowchart of FIG. 8, the explanation of the behavior determining processing will be omitted hereafter.

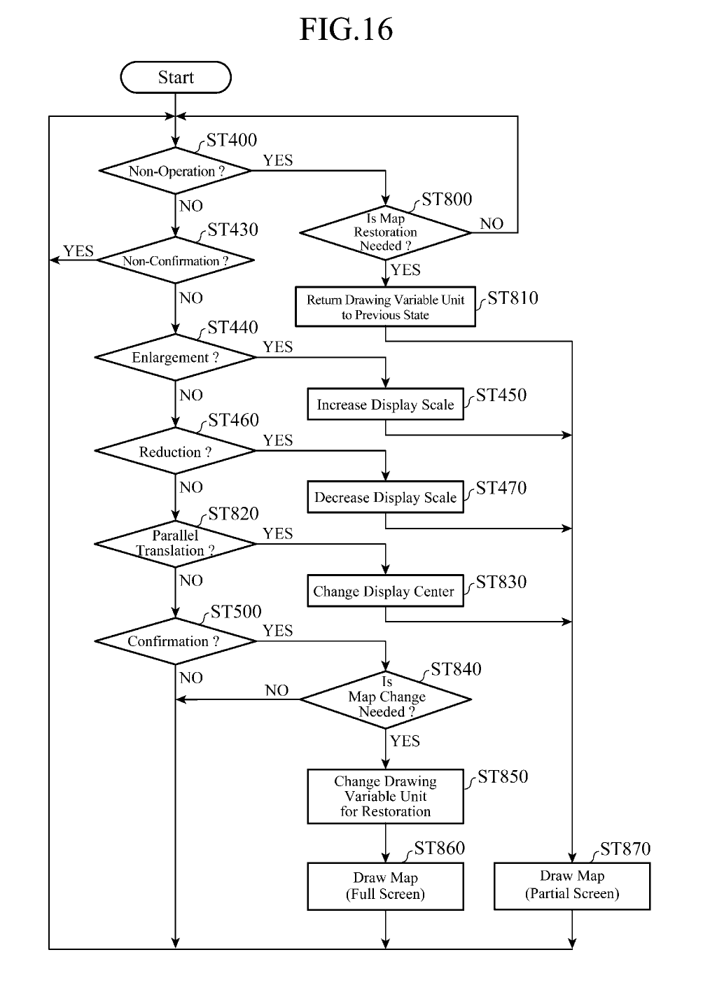

FIG. 16 is a flow chart showing the operation of the map drawing unit 13 of a control unit 7. In the flow chart shown in FIG. 16, steps in which the same processes as those carried out by the map information processing device in accordance with Embodiment 1 shown in the flow chart of FIG. 9 are performed are designated by the same reference characters as those shown in FIG. 9, and the explanation of the processes will be simplified hereafter.

First, whether or not the user operation is a non-operation is checked to see (step ST400). When it is determined, in this step ST400, that the user operation is a non-operation, whether or not there is a necessity to restore the map is then checked to see (step ST800). More specifically, the map drawing unit 13 compares the display scale stored in the drawing variable unit 31 with that stored in the drawing variable unit 32 for restoration, and, when they are not the same as each other, determines that there is a necessity to restore the map currently being displayed to a state in which the map was previously placed before the operation has been performed, whereas when they are the same as each other, the map drawing unit determines that there is no necessity to restore the map currently being displayed to the previous state.

When it is determined, in above-mentioned step ST800, that there is no necessity to restore the map, the sequence is returned to step ST400 and the above-mentioned processing is repeated. In contrast, when it is determined, in step ST800, that there is a necessity to restore the map, the drawing variable unit 31 is then returned to its previous state (step ST810). More specifically, the map drawing unit 13 reads the display scale stored in the drawing variable unit 32 for restoration, and stores the display scale in the drawing variable unit 31. After that, the sequence is advanced to step ST870.

When it is determined, in above-mentioned step ST400, that the user operation is not a non-operation, whether or not the user operation is a non-confirmation one is then checked to see (step ST430). When it is determined, in this step ST430, that the user operation is a non-confirmation one, the sequence is returned to step ST400 and the above-mentioned processing is repeated.

In contrast, when it is determined, in step ST430, that the user operation is not a non-confirmation one, whether or not the user operation is an enlarging one is then checked to see (step ST440). When it is determined, in this step ST440, that the user operation is an enlarging one, the display scale is increased (step ST450). After that, the sequence is advanced to step ST870.

In contrast, when it is determined, in above-mentioned step ST440, that the user operation is not an enlarging one, whether or not the user operation is a reducing one is then checked to see (step ST460). When it is determined, in this step ST460, that the user operation is a reducing one, the display scale is decreased (step ST470). After that, the sequence is advanced to step ST870.

In contrast, when it is determined, in above-mentioned step ST460, that the user operation is not a reducing one, whether or not the user operation is a translating one is then checked to see (step ST820). More specifically, the map drawing unit 13 refers to the operation specification unit 22 to check to see whether or not the code stored in the operation specification unit is a translation one. When it is determined, in this step ST820, that the user operation is a translating one, the display center is changed (step ST830). More specifically, the map drawing unit 13 overwrites the display center coordinates stored in the drawing variable unit 31 of a memory of the control unit 7 with the X and Y coordinates which are stored in the operation specification unit 22. After that, the sequence is advanced to step ST870.

In contrast, when it is determined, in above-mentioned step ST820, that the user operation is not a translating one, whether or not the user operation is a confirmation one is then checked to see (step ST500). When it is determined, in this step ST500, that the user operation is a confirmation one, whether or not there is a necessity to change the map is then checked to see (step ST840). More specifically, the map drawing unit 13 compares the display scale stored in the drawing variable unit 31 with the display scale stored in the drawing variable unit 32 for restoration, and, when they are not the same as each other, determines that there is a necessity to change the map currently being displayed, whereas when they are the same as each other, the map drawing unit determines that there is no necessity to change the map.

When it is determined, in this step ST840, that there is a necessity to change the map, the contents of the drawing variable unit 32 for restoration are changed (step ST850). More specifically, the map drawing unit 13 reads the display scale from the drawing variable unit 31, and stores the display scale in the drawing variable unit 32 for restoration. Map drawing (full screen) is then performed (step ST860). More specifically, in order to apply the display scale of a screen portion in the vicinity of a point to which the user brings his or her finger close to the full screen, as shown in FIG. 15, the map drawing unit 13 acquires needed map data which has the display scale stored in the drawing variable unit 31 and which make the map coordinates of a point corresponding to the center of the display surface of the display unit 8 be equal to the display center coordinates stored in the drawing variable unit 32 for restoration from a map database storage unit 6, and performs map drawing. After that, the sequence is returned to step ST400, and the above-mentioned processing is repeated. Further, when it is determined, in above-mentioned step ST500, that the user operation is not a confirmation one, and also when it is determined, in step ST840, that there is no necessity to change the map, the sequence is returned to step ST400 and the above-mentioned processing is repeated.

Map drawing (partial screen) is performed in step ST870. More specifically, in order to draw only a map of a neighboring area at a fixed distance or less from the display center coordinates stored in the drawing variable unit 31 with the display scale stored in the drawing variable unit 31, the map drawing unit 13 acquires map data needed for this drawing from the map database storage unit 6, and performs map drawing. After that, the sequence is returned to step ST400, and the above-mentioned processing is repeated.

As previously explained, because the map information processing device in accordance with Embodiment 3 of the present invention is constructed in such away as to change the display scale of a map portion while limiting this map portion to a neighboring area in the vicinity of a position touched by the user's finger, the map information processing device produces an enlarged display of only a map portion in the vicinity of a position touched by the user's finger without changing the display scale of the full screen to enable the user to view the details of only the map portion and determine whether or not to change the scale of the full screen map while comparing the map portion with the full screen map whose scale has yet to be changed. Further, because the map information processing device keeps the display of the map having the original scale on the background when temporarily changing the scale of only a map portion in the vicinity of a position touched by the user's finger, the user does not have to keep the original scale in mind in order to restore the map portion to its previous scale, and can restore the screen to its previous state in which the original map is displayed (change the screen) through a brief operation.

### Embodiment 4

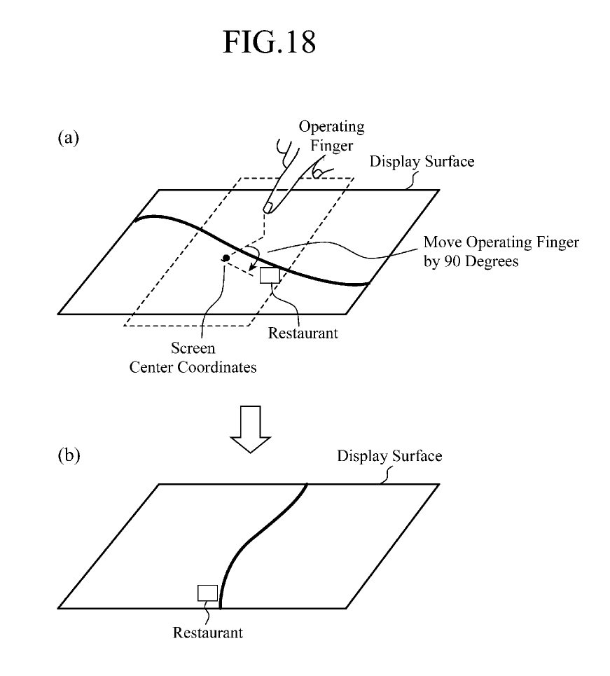

A map information processing device in accordance with Embodiment 4 of the present invention produces a fixed screen without allowing the user to scroll the screen, and rotates a map by an arbitrary angle according to a moving angle and a direction of rotation of the user's finger to display the map. FIG. 18 is a view showing an operation example in the map information processing device in accordance with Embodiment 4. An example in which a map which is rotated clockwise by 90 degrees by a 90-degree rotational movement of an operating finger is displayed is shown. In this example, because the ratio of height to width is not equal to 1:1, only a dashed line portion shown in FIG. 18(a) is displayed. Hereafter, a portion different from the map information processing device in accordance with Embodiment 1 will be explained.

A display scale, display center coordinates, and a display angle are stored in a drawing variable unit 31 of a map drawing unit 13. In an initial state, a predetermined display scale, predetermined display center coordinates, and a predetermined display angle are stored. The same goes for a drawing variable unit 32 for restoration.

Behaviors determined in step ST110 of FIG. 3 are a non-operation, a rotating operation, a confirmation operation, and a non-confirmation operation. A method of determining whether a non-operation or a confirmation operation has been performed, and a process which the map information processing device performs after the determination are the same as those in the case of the map information processing device in accordance with above-mentioned Embodiment 1.

When tracing touch positions stored in a touch position locus storage unit 21 in reverse chronological order, from the most recent one to older ones, and then determining that the X and Y coordinates have varied, the map information processing device determines that the user operation is a “rotating” operation. At this time, the most recent X and Y coordinates, the direction of rotation, and the moving angle are stored in an operation specification unit 22. The direction of rotation is calculated from a comparison between the position shown by the current X and Y coordinates, and the position shown by the previous X and Y coordinates.

The moving angle is calculated from a comparison of the difference in angle between a straight line extending from the position shown by the previous X and Y coordinates to the display center coordinates stored in the drawing variable unit 31, and a straight line extending from the position shown by the current X and Y coordinates to the display center coordinates stored in the drawing variable unit 31. Because the user has not rotated the map yet when no previous X and Y coordinates exist (e.g. when the comparison which is performed this time is the first-time one), 0 is stored as the moving angle. The map information processing device determines that the user operation is a “non-confirmation” one when determining that the user's fingers have been stopped or no operation associated with rotation of a map or confirmation has been carried out.

Next, the operation of the map information processing device in accordance with this Embodiment 4 will be explained. Because behavior determining processing carried out by this map information processing device is the same as that carried out by the map information processing device in accordance with Embodiment 1 shown in the flow chart of FIG. 8, the explanation of the behavior determining processing will be omitted hereafter.

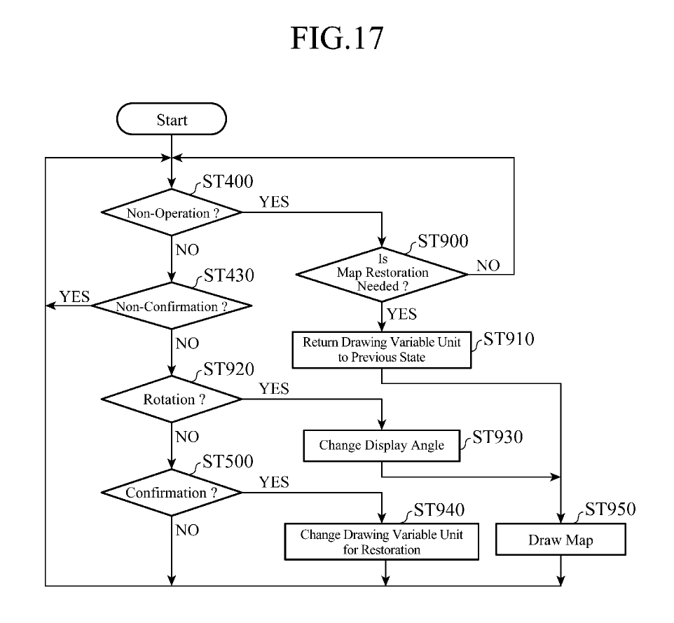

FIG. 17 is a flow chart showing the operation of the map drawing unit 13 of a control unit 7. In the flow chart shown in FIG. 17, steps in which the same processes as those carried out by the map information processing device in accordance with Embodiment 1 shown in the flow chart of FIG. 9 are performed are designated by the same reference characters as those shown in FIG. 9, and the explanation of the processes will be simplified hereafter.

First, whether or not the user operation is a non-operation is checked to see (step ST400). When it is determined, in this step ST400, that the user operation is a non-operation, whether or not there is a necessity to restore the map is then checked to see (step ST900). More specifically, the map drawing unit 13 compares the display angle stored in the drawing variable unit 31 with the display angle stored in the drawing variable unit 32 for restoration, and, when they are not the same as each other, determines that there is a necessity to restore the map, whereas when they are the same as each other, the map drawing unit determines that there is no necessity to restore the map.

When it is determined, in above-mentioned step ST900, that there is no necessity to restore the map, the sequence is returned to step ST400 and the above-mentioned processing is repeated. In contrast, when it is determined, in step ST900, that there is a necessity to restore the map, the drawing variable unit 31 is then returned to its previous state (step ST810). More specifically, the map drawing unit 13 reads the display angle from the drawing variable unit 32 for restoration, and stores the display angle in the drawing variable unit 31. After that, the sequence is advanced to step ST950.

When it is determined, in above-mentioned step ST400, that the user operation is not a non-operation, whether or not the user operation is a non-confirmation one is then checked to see (step ST430). When it is determined, in this step ST430, that the user operation is a non-confirmation one, the sequence is returned to step ST400 and the above-mentioned processing is repeated.

In contrast, when it is determined, in step ST430, that the user operation is not a non-confirmation one, whether or not the user operation is a rotating one is then checked to see (step ST920). More specifically, the map drawing unit 13 refers to the operation specification unit 22 to check to see whether or not a code stored in the operation specification unit is a rotation one. When it is determined, in this step ST920, that the user operation is a rotating one, the display angle is changed (step ST930). More specifically, the map drawing unit 13 increases or decrease the display angle stored in the drawing variable unit 31 by the moving angle stored in the operation specification unit 22. More specifically, the map drawing unit refers to the direction of rotation stored in the operation specification unit 22, and, when the direction of rotation is a clockwise one, increases the display angle, whereas when the direction of rotation is a counterclockwise one, the map drawing unit decreases the display angle. When the changed display angle exceeds 360 degrees, the map drawing unit subtracts 360 from the calculated value and stores the subtraction result in the drawing variable unit. Further, when the changed display angle is smaller than 0, the map drawing unit subtracts the absolute value of the calculated value from 360 and stores the subtraction result in the drawing variable unit. For example, when the calculated value is −20, 360−20=340 is stored in the drawing variable unit. After that, the sequence is advanced to step ST950.

In contrast, when it is determined, in above-mentioned step ST920, that the user operation is not a rotating one, whether or not the user operation is a confirmation one is then checked to see (step ST500). When it is determined, in this step ST500, that the user operation is a confirmation one, the contents of the drawing variable unit 32 for restoration are changed (step ST940). More specifically, the map drawing unit 13 reads the display angle from the drawing variable unit 31, and stores the display angle in the drawing variable unit 32 for restoration. After that, the sequence is returned to step ST400 and the above-mentioned processing is then repeated. Further, also when it is determined, in above-mentioned step ST500, that the user operation is not a confirmation one, the sequence is returned to step ST400, and the above-mentioned processing is then repeated.

Map drawing is performed in step ST950. More specifically, the map drawing unit 13 acquires needed map data which has the display angle and the display scale stored in the drawing variable unit 31 and which make the map coordinates of a point corresponding to the center of the display surface of the display unit 8 be equal to the display center coordinates stored in the drawing variable unit 31 from a map database storage unit 6, and performs map drawing. After that, the sequence is returned to step ST400, and the above-mentioned processing is then repeated.

As explained above, because the map information processing device in accordance with Embodiment 4 of the present invention is constructed in such a way as to rotate the map according to the direction of rotation and the amount of movement of the user's finger, the map information processing device enables the user to cause the map information processing device to change the direction of display of the map through an intuitively intelligible operation. The map information processing device can be constructed in such a way as to, when the user moves his or her finger towards a position which cannot be detected by the touch panel 2, return the map to the map oriented in the original display direction.

### Embodiment 5

A map information processing device in accordance with Embodiment 5 of the present invention produces a fixed screen without allowing the user to scroll the screen, and draws only a map portion in the vicinity of a position to which the user brings his or her finger close in another display mode (displays a bird's eye view or a three-dimensional map). More specifically, the map information processing device displays a map of a certain area in the vicinity of a position to which the user brings his or her finger close in a display mode (display style) different from that in which a map other than the map of the certain area is displayed. FIGS. 13 and 14 are views showing operation examples in the map information processing device in accordance with Embodiment 5. Hereafter, a portion different from the map information processing device in accordance with Embodiment 1 will be explained.

A display scale, the display center coordinates of a display change surface portion, and a display mode are stored in a drawing variable unit 31 disposed in a map drawing unit 13. In an initial state, a predetermined display scale, predetermined display center coordinates, and a predetermined display mode are stored. Further, a display scale, the display center coordinates of a display fixed surface portion, and a display mode are stored in a drawing variable unit 32 for restoration. In an initial state, a predetermined display scale, predetermined display center coordinates, and a predetermined display mode are stored.

Behaviors determined in step ST110 of FIG. 3 are a non-operation, a translating operation, a confirmation operation, and a non-confirmation operation. A method of determining whether a non-operation or a confirmation operation has been performed, and a process which the map information processing device performs after the determination are the same as those in the case of the map information processing device in accordance with above-mentioned Embodiment 1.

When tracing touch positions stored in a touch position locus storage unit 21 in reverse chronological order, from the most recent one to older ones, and then determining that the X and Y coordinates have varied, the map information processing device that the user operation is a “translating” operation. In order to change the scale of a map of a neighboring area at a fixed distance or less from the point having the most recent X and Y coordinates at this time to draw the map in a different display mode, the map information processing device stores the most recent X and Y coordinates in an operation specification unit 22. In this case, whether the Z coordinate has varied is insignificant. The map information processing device determines that the user operation is a “non-confirmation” one when determining that the user's fingers have been stopped or no operation associated with translation of a map or confirmation has been carried out.

Next, the operation of the map information processing device in accordance with this Embodiment 5 will be explained. Because behavior determining processing carried out by this map information processing device is the same as that carried out by the map information processing device in accordance with Embodiment 1 shown in the flow chart of FIG. 8, the explanation of the behavior determining processing will be omitted hereafter.

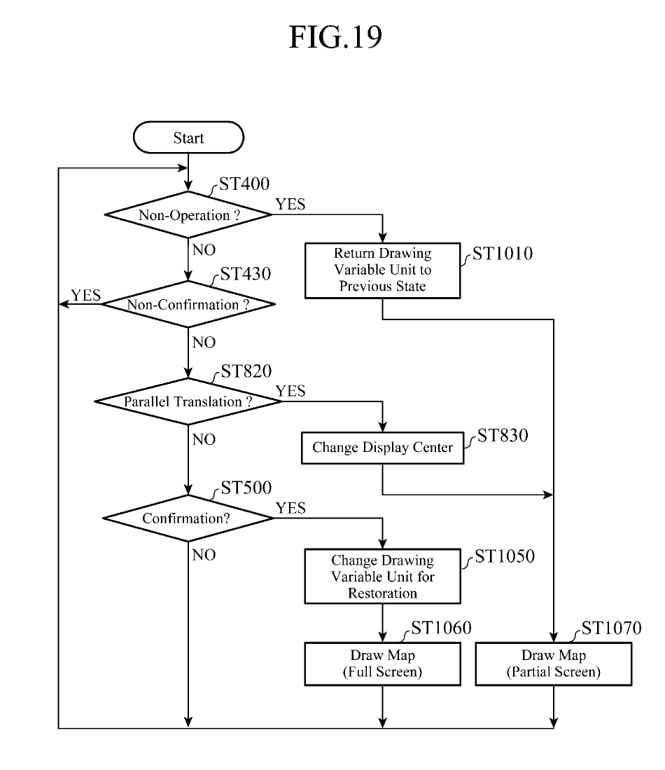

FIG. 19 is a flow chart showing the operation of a map drawing unit 13 of a control unit 7. In the flow chart shown in FIG. 19, steps in which the same processes as those carried out by the map information processing device in accordance with Embodiment 4 shown in the flow chart of FIG. 16 are performed are designated by the same reference characters as those shown in FIG. 16, and the explanation of the processes will be simplified hereafter.

First, whether or not the user operation is a non-operation is checked to see (step ST400). When it is determined, in this step ST400, that the user operation is a non-operation, the drawing variable unit 31 is then returned to its previous state (step ST1010). More specifically, in order to draw a normal map of a neighboring area at a fixed distance or less from the display center coordinates stored in the drawing variable unit 31, the map drawing unit 13 reads the display mode from the drawing variable unit 32 for restoration, and stores this display mode in the drawing variable unit 31. After that, the sequence is advanced to step ST1070.

When it is determined, in above-mentioned step ST400, that the user operation is not a non-operation, whether or not the user operation is a non-confirmation one is then checked to see (step ST430). When it is determined, in this step ST430, that the user operation is a non-confirmation one, the sequence is returned to step ST400 and the above-mentioned processing is repeated.

In contrast, when it is determined, in step ST430, that the user operation is not a non-confirmation one, whether or not the user operation is a translating one is then checked to see (step ST820). When it is determined, in this step ST820, that the operation is a translating one, the display center is changed (step ST830). After that, the sequence is advanced to step ST1070.

In contrast, when it is determined, in above-mentioned step ST820, that the user operation is not a translating one, whether or not the user operation is a confirmation one is then checked to see (step ST500). When it is determined, in this step ST500, that the user operation is a confirmation one, the contents of the drawing variable unit 32 for restoration are then changed (step ST1050). More specifically, the map drawing unit 13 reads the display mode from the drawing variable unit 31, and stores the display mode in the drawing variable unit 32 for restoration.

Map drawing (full screen) is then performed (step ST1060). More specifically, in order to apply the display scale of a screen portion in the vicinity of a point to which the user brings his or her finger close to the full screen, as shown in FIG. 15, the map drawing unit 13 acquires needed map data which has the display mode and the display scale stored in the drawing variable unit 31 and which make the map coordinates of a point corresponding to the center of the display surface of the display unit 8 be equal to the display center coordinates stored in the drawing variable unit 32 for restoration from a map database storage unit 6, and performs map drawing. After that, the sequence is returned to step ST400, and the above-mentioned processing is repeated. Further, also when it is determined, in above-mentioned step ST500, that the user operation is not a confirmation one, the sequence is returned to step ST400 and the above-mentioned processing is repeated.

Map drawing (partial screen) is performed in step ST1070. More specifically, in order to draw a map of a neighboring area at a fixed distance or less from the display center coordinates stored in the drawing variable unit 31 in the display mode stored in the drawing variable unit 31 and with the display scale stored in the drawing variable unit 31, the map drawing unit 13 acquires map data needed for this drawing from the map database storage unit 6, and performs map drawing. After that, the sequence is returned to step ST400, and the above-mentioned processing is repeated.

As previously explained, the map information processing device in accordance with Embodiment 5 of the present invention changes the display mode of a map portion while limiting this map portion to a neighboring area in the vicinity of a position touched by the user's finger, thereby being able to change the display of the map temporarily to enable the user to view the map portion without changing the display mode of the full screen. Further, the map information processing device can limit the change of the display mode to the map portion in the vicinity of the position touched by the user's finger and move the map portion, thereby enabling the user to view only the needed map portion in a different display mode in the entire map displayed on the screen of the touch panel.

### INDUSTRIAL APPLICABILITY

The present invention can be used particularly for a car navigation system which is requested to enable the user to cause the car navigation system to change the display of a map by performing a simple operation.

1.-14. (canceled)

15. A map information processing device comprising:
a display unit for displaying a map;
a three-dimensional input unit for detecting a three-dimensional position of an object to be detected with respect to a display surface of said display unit; and
a control unit for displaying a map having a same display center as an original display position on said display unit in such a way as to enlarge the map as the object to be detected which is detected by said three-dimensional input unit gets close to said display surface and reduce the map as the object to be detected moves away from said display surface, to scroll the map in a direction determined on a basis of a locus of movements of said object to be detected while maintaining a scale according to a distance between said object to be detected and said display surface to display the map on said display unit when said object to be detected moves along said display surface while maintaining the distance between said object to be detected and said display surface, and to enlarge the map as said object to be detected gets close to said display surface from a position to which the map has been scrolled and reduce the map as the object to be detected moves away from said display surface from the position.

16. The map information processing device according to claim 15, wherein said control unit selects a scale map according to the distance between said object to be detected and said display surface from among a plurality of scale display maps to enlarge or reduce the map and display the map on said display unit.

17. The map information processing device according to claim 15, wherein said control unit enlarges or reduces the map around a position on said display surface opposite to the position of the object to be detected which is detected by said three-dimensional input unit.

18. A map information processing device comprising:
a display unit for displaying a map;
a three-dimensional input unit for detecting a three-dimensional position of an object to be detected with respect to a display surface of said display unit; and
a control unit for, when determining a scroll direction on a basis of a locus of movements of the object to be detected which is detected by said three-dimensional input unit, scrolling the map in a direction predetermined according to a directional relationship between a movement direction of said object to be detected and said scroll direction to display the map on said display unit.

19. The map information processing device according to claim 18, wherein when said object to be detected moves in a direction substantially opposite to said scroll direction, said control unit does not scroll the map in said opposite direction.

20. The map information processing device according to claim 18, wherein when said object to be detected moves in a direction substantially opposite to said scroll direction, said control unit does not scroll the map in said opposite direction, whereas when the object to be detected in moves in another direction, said control unit scroll the map in a direction of the movement of said object to be detected.

21. The map information processing device according to claim 18, wherein when said object to be detected moves in a direction which is substantially same as said scroll direction, said control unit scrolls the map in said scroll direction.

22. A map information processing device comprising:
a display unit for displaying a map;
a three-dimensional input unit for detecting a three-dimensional position of an object to be detected with respect to a display surface of said display unit; and
a control unit for displaying a map of a predetermined area including a position on said display surface opposite to the position of the object to be detected which is detected by said three-dimensional input unit on said display unit in such a way as to enlarge the map as said object to be detected gets close to said display surface and reduce the map as said object to be detected moves away from said display surface, and for, after detecting that a locus of movements of said object to be detected has a predetermined pattern or a predetermined operation is performed, displaying an entire portion including a map other than the map of said predetermined area with a scale according to a distance from said display surface to said object to be detected.

23. A map information processing device comprising:
a display unit for displaying a map;
a three-dimensional input unit for detecting a three-dimensional position of an object to be detected with respect to a display surface of said display unit; and
a control unit having a function of displaying a map by using a first map display method and a function of displaying a map by using a second map display method, wherein
said control unit displays a map of a predetermined area including a position on said display surface opposite to the position of the object to be detected which is detected by said three-dimensional input unit on said display unit by using said second map display method, and displays a map other than the map of said predetermined area on said display unit by using said first map display method.

24. The map information processing device according to claim 23, wherein after detecting that a locus of movements of said object to be detected has a predetermined pattern or a predetermined operation is performed, the control unit displays an entire portion including the map other than the map of said predetermined area by using said second display method.

25. The map information processing device according to claim 23, wherein said first map display method is the one of displaying a map in a two-dimensional form, and said second map display method is the one of displaying a map with a bird's eye view or in a three-dimensional form.

26. The map information processing device according to claim 24, wherein said first map display method is the one of displaying a map in a two-dimensional form, and said second map display method is the one of displaying a map with a bird's eye view or in a three-dimensional form.
